(19) United States
(12) Patent Application Publication
(10) Pub. No.: US 2026/0044535 A1
(43) Pub. Date: Feb. 12, 2026

(54) DATA ANALYSIS TO CREATE REAL-TIME DATA GENERATION

(71) Applicant: Bank of America Corporation, Charlotte, NC (US)

(72) Inventors: Pavan Gulhane, Oakville Ontario (CA); Manu Kurian, Dallas, TX (US); Michael G. Horstman, Chicago, IL (US)

(21) Appl. No.: 18/735,694

(22) Filed: Jun. 6, 2024

(51) Int. Cl. G06F 16/28; G06F 9/451

(52) U.S. Cl. CPC G06F 16/287; G06F 9/451

(57) ABSTRACT

Apparatus for dynamically modifying a report in real-time, the report being generated through the use of a quantum computing system. An artificial intelligence machine learning module collects data. One or more quantum computing processors analyze the data. The analyzed data is classified into classifications. The classifications are associated with one or more report types. The quantum computing system generates the report based upon a user selection of a report type. The user manipulates the report by viewing the data used to generate the report, updating the data used to generate the report, viewing the parameters of the report type, updating the parameters of the report type. The quantum computing system generates a new report based on the updated data and updated parameters.

### FIELD OF TECHNOLOGY

Aspects of the disclosure relate to quantum computing and manipulation of reports.

### BACKGROUND OF THE DISCLOSURE

Entities include applications which generate reports. The reports are generated for various reasons and for various users. Reports may be generated on performance, finance, sales, research, inventory, trends, analytics and any other suitable topic. Entities generate the reports at set intervals or on demand. The applications generate the reports using predetermined report formats. The predetermined report formats may fail to present all the information needed by a user. The predetermined report formats may be incapable of customization. The predetermined report formats may lack the most recent information. The applications may be incapable of processing live information swiftly or accurately to include in the reports.

It would be desirable for a user to be able to customize the report. It would be further desirable to generate the reports using live information.

It would be further desirable to provide a system which enables the user to customize the report based on the user’s needs.

It would be yet further desirable for the system to include a quantum computing system.

When higher report generation speeds using real-time information are needed or preferred, it would be yet further desirable for the quantum computing system to process live data feeds to incorporate into the report.

### SUMMARY OF THE DISCLOSURE

Apparatus, methods and systems for generating and manipulating reports are provided.

A quantum computing system may include a quantum computing processor. The quantum computing system may dynamically modify a report in real-time. The report may be generated by the quantum computing system. The quantum computing system may include an artificial intelligence machine learning (“AI/ML”) module.

The AI/ML module may collect a plurality of data from a plurality of data sources. The plurality of data sources may include previously generated reports, data from a centralized database and/or publicly accessible sources. The previously generated reports may be generated by the quantum computing system prior to the current report. The previously generated reports may be generated by a different system. The centralized database may be stored in the quantum computing system. The centralized database may be stored separately from the quantum computing system. The publicly accessible sources may include the internet, public library database or any other publicly accessible sources.

The AI/ML module may classify the plurality of data into one or more classifications. Each data entry may be classified into one or more classifications. The AI/ML may associate the classifications with one or more report types. Each report type may be associated with one or more classifications. Each report type may include one or more parameters. The quantum computing system may run the data through the parameters to generate the report.

The quantum computing system may generate a report based on a user request. The quantum computing system may generate the report at a predetermined time. A user may select the report type before the report is generated. The report may be generated using the parameters set out in the report type. The report may be generated by feeding the data classified in the at least one classification associated with the selected report type through a report generation module. The quantum computing system may include the report generation module.

The user may manipulate the report through a report manipulation module. The quantum computing system may include the report manipulation module. The report manipulation module may be in communication with a user interface (“UI”). The report manipulation module may show the user the data used to generate the report. The data may be viewed by the user on the UI. The user may update the data used to generate the report via the report manipulation module. The user may add to, remove or edit portions of the data used to generate the report. The user may update the parameters of the report type via the report manipulation module. The user may add to, remove or edit portions of the parameters used to generate the report. The report manipulation module may generate a new report using the updated data and parameters.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative diagram in accordance with principles of the disclosure;

FIG. 2 shows another illustrative diagram in accordance with principles of the disclosure;

FIG. 3 shows an illustrative flow diagram in accordance with principles of the disclosure; and

FIG. 4 shows another illustrative diagram in accordance with the principles of the disclosure.

### DETAILED DESCRIPTION OF THE DISCLOSURE

Apparatus, methods and systems for implementing quantum computing and methods for generating reports are provided.

Methods may be used for implementing a quantum computing system to generate reports using live data and manipulate reports live. Methods may include collecting a plurality of data. An artificial intelligence machine learning (“AI/ML”) module may collect the plurality of data from a plurality of data sources. The plurality of data sources may include previously generated reports, data from a centralized database and publicly accessible sources.

The previously generated reports may have been generated by the quantum computing system. The previously generated reports may have been generated from a system different than the quantum computing system. The previously generated reports may be stored in a generated reports database. The AI/ML may access the previously generated reports from the generated reports database. The AI/ML may search for previously generated reports generated by an application different from the quantum computing system. The AI/ML may search for previously generated reports in the centralized database and the publicly accessible sources. The AI/ML may store any previously generated reports found in the search in the generated reports database.

The previously generated reports may inform the quantum computing system of typical information included in different report types. The previously generated reports may include information that is capable of being reused for a new report.

The centralized database may include data relevant to generating reports. The centralized database may include information relating to the entity, including employee records, financial records, research records, performance records, sales records, inventory records and/or any other suitable type of records.

The publicly accessible sources may include data relevant to generating reports. The AI/ML may search the publicly accessible sources for the desired data based on the relevant report type being generated. The AI/ML may search a predetermined number of publicly accessible sources. The AI/ML may collect specific data from predetermined publicly accessible sources. The AI/ML may collect all data from the predetermined publicly accessible sources.

The AI/ML may collect data from a predetermined number of each of the plurality of sources. The AI/ML may collect a predetermined amount of data from each of the plurality of sources. The AI/ML may dynamically collect the data. The AI/ML may collect the data at predetermined intervals. The AI/ML may collect the data upon a request to generate a report. The AI/ML may store new relevant data collected from the plurality of sources. The AI/ML may store the relevant data in the centralized database.

The AI/ML may delete unneeded data. The AI/ML may delete duplicate data. The AI/ML may delete data that has been unused for a predetermined amount of time. The AI/ML may delete data that is older than a predetermined amount of time.

Data elements collected from publicly accessible sources may include information that can be shared, used, reused and/or redistributed without restriction. The data may be collected from private sources. Data collected from private sources may include personal, personally identifiable, financial, sensitive or regulated information relating to a specific person or entity.

Methods may further include shrinking the data using one or more quantum computing processors. The quantum computing processors may shrink the data relevancy-wise and size-wise. The quantum computing processors may shrink the data relevancy-wise to include data applicable to a single user. The quantum computing processors may shrink the data size-wise to provide the system with reduced datasets. Shrinking the data size-wise may include reducing the size of a dataset. The size of a dataset may be reduced by converting an audio file into a text file, while retrieving statistics associated with the audio file.

The shrinking of the data may be performed using one or more quantum algorithms that have been created with the one or more quantum computing processors. The quantum algorithms may be an algorithm that converts speech-to-text. The quantum computing processor may convert the audio file into a text file while retrieving the statistics associated with the audio file.

Methods may further include analyzing the data using the one or more quantum computing processors. The one or more quantum computing processors may analyze the data. The data analyzed may be applicable for use in generating the report. Current generation of reports may be incapable of including live data. Live data may come from various sources that produce live feeds of data. Current computer processors may be incapable of collecting and analyzing live data due to the number of data sources and amount of available data. A quantum computing system, such as one described herein, may collect and analyze vast amounts of data. The quantum computing system may utilize the quantum computing processors to collect and analyze the live data. The quantum computing system may thereby provide updated reports based on live information.

Analyzing the data may include classifying the plurality of data. The plurality of data may be classified into one or more classifications. The classifications may be further subdivided into subclassifications. The classifications may include finance data, employee data, research data, inventory data, etc. The subclassifications for finance data may include finance data for each department, different types of finance data, etc. Each data portion may be classified into one or more classifications.

The one or more classifications and subclassifications may be associated with one or more report types. The report types may include one or more parameters. The report types may include for example, financial reports, research reports, progress reports, inventory reports etc. The parameters may be used to generate the reports. The report type may require certain information needed to generate the report. The information needed to generate the report may be found in the data classified in certain classifications.

The quantum computing system may generate the report at predetermined intervals. the quantum computing system may generate the report based on a user request. The user may select a report type from the one or more report types. The quantum computing system may generate a report based on the report type selected by the user. The quantum computing system may generate the report by feeding the data, classified into the classifications associated with the report type selected by the user, into the report generation module of the quantum computing system. The report generation module may process the data and generate a report based on the parameters of the report type.

The AI/ML may collect new data upon a user request to generate a report. The AI/ML may collect the new data dynamically. The AI/ML may classify the data dynamically. The AI/ML may associate the classifications dynamically. For the purposes of this application, dynamically means in real-time. The AI/ML may collect the data dynamically from multiple live data feeds. The plurality of data sources may include the multiple live data feeds.

The AI/ML may create, before the classifying of the data, datapoints upon collecting the data feed. The datapoints may represent information relating to the data. The datapoints may be stored in the centralized database. The AI/ML may include a neutral data aggregator to manage the live data feeds. The neutral data aggregator may classify the data. The neutral data aggregator may organize the classified data. The neutral data aggregator may create the datapoints.

The quantum computing system may verify the data received from the publicly accessible sources. The verification may include comparing the newly collected data to previously collected data. The verification may include comparing the newly collected data to other data sources. The quantum computing system may utilize its vast data processing capabilities to verify live data. The quantum computing system may utilize its vast data processing capabilities to collect, classify, associate, manipulate and analyze live data.

Methods may include manipulating the report generated by the quantum computing system. The user may manipulate the report via a report manipulation module. The quantum computing system may include the report manipulation module. The manipulation may include viewing the data used to generate the report on a user interface (“UI”), updating the data used to generate the report, viewing the parameters of the report type and/or updating the parameters of the report type.

The user may desire to manipulate the report. The user may desire to understand which datapoints were used in generating the report. The user may view the data used to generate the report via the report manipulation module on the UI. The user may view the parameters of the report type via the report manipulation module on the UI. The UI may show the user the report and a field for an input on the same screen as the report. The user may enter an input into the field to manipulate the report. The user may rearrange the results of the report. The user may update the data used to generate the report. The user may add to, remove or edit portions of the data used to generate the report. The user may add to, remove or edit portions of the parameters used in the report type. The report manipulation module may generate a new report in response to the user input. The report manipulation module may generate the new report dynamically. The user may request the report manipulation module to regenerate the report using live data. The report manipulation module may update the report automatically using live data at predetermined intervals.

The user may create a new report type via the report manipulation module. The user may save the updated report type as a new report type. The user may indicate which parameters should be included in the new report type. The user may manipulate the classifications. The user may add to, remove or edit classifications. The user may view the classifications on the UI. The user may change how the data gets classified.

The report manipulation module may include a generative AI engine. The generative AI engine may receive the input from the user. The input from the user may be in natural language form rather than a computer language. The generative AI engine may include a natural language processor (“NLP”). The NLP may analyze the user input for a user intent. The generative AI engine may manipulate the report based on the user intent.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is to be understood that other embodiments may be utilized, and that structural, functional and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

The drawings show illustrative features of apparatus and methods in accordance with the principles of the invention. The features are illustrated in the context of the selected embodiments. It will be understood that features shown in connection with one of the embodiments may be practiced in accordance with the principles of the invention along with features shown in connection with another of the embodiments.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer readable data structures.

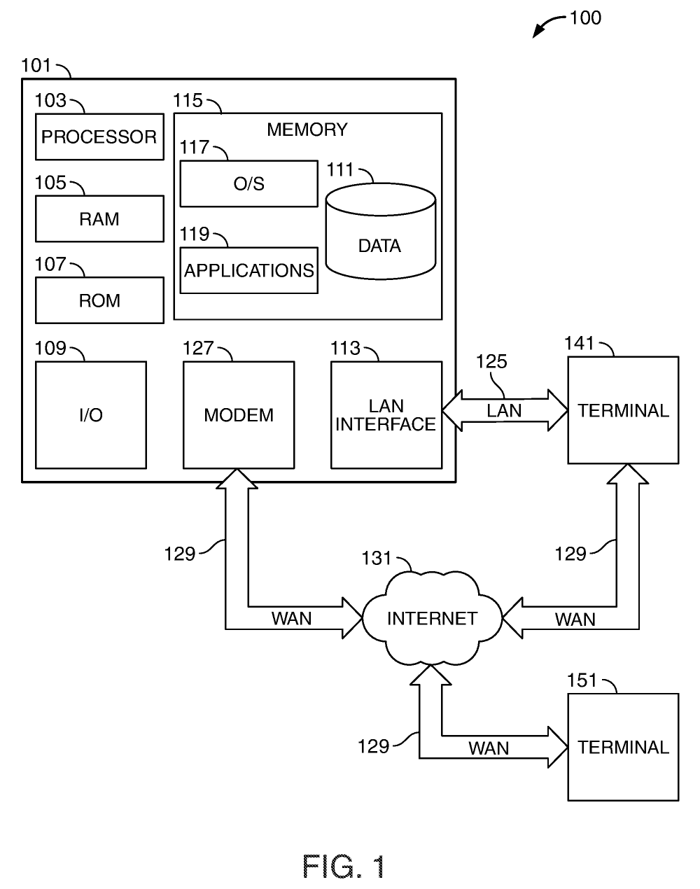

FIG. 1 shows an illustrative block diagram of system 100 that includes computer 101. Computer 101 may alternatively be referred to herein as a "server” or a “computing device." Computer 101 may be a workstation, desktop, laptop, tablet, smart phone, or any other suitable computing device. Elements of system 100, including computer 101, may be used to implement various aspects of the systems and methods disclosed herein.

Computer 101 may have a processor 103 for controlling the operation of the device and its associated components, and may include RAM 105, ROM 107, input/output module 109, and a memory 115. The processor 103 may also execute all software running on the computer—e.g., the operating system and/or voice recognition software. Other components commonly used for computers, such as EEPROM or Flash memory or any other suitable components, may also be part of the computer 101.

The memory 115 may be comprised of any suitable permanent storage technology—e.g., a hard drive. The memory 115 may store software including the operating system 117 and application(s) 119 along with any data 111 needed for the operation of the system 100. Memory 115 may also store videos, text, and/or audio assistance files. The videos, text, and/or audio assistance files may also be stored in cache memory, or any other suitable memory. Alternatively, some or all of computer executable instructions (alternatively referred to as “code”) may be embodied in hardware or firmware (not shown). The computer 101 may execute the instructions embodied by the software to perform various functions.

Input/output (“I/O”) module may include connectivity to a microphone, keyboard, touch screen, mouse, and/or stylus through which a user of computer 101 may provide input. The input may include input relating to cursor movement. The input/output module may also include one or more speakers for providing audio output and a video display device for providing textual, audio, audiovisual, and/or graphical output. The input and output may be related to computer application functionality.

System 100 may be connected to other systems via a local area network (LAN) interface 113.

System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (LAN) 125 and a wide area network (WAN) 129 but may also include other networks. When used in a LAN networking environment, computer 101 is connected to LAN 125 through a LAN interface or adapter 113. When used in a WAN networking environment, computer 101 may include a modem 127 or other means for establishing communications over WAN 129, such as Internet 131.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit a user to retrieve web pages from a web-based server. The web-based server may transmit data to any other suitable computer system. The web-based server may also send computer-readable instructions, together with the data, to any suitable computer system. The computer-readable instructions may be to store the data in cache memory, the hard drive, secondary memory, or any other suitable memory.

Additionally, application program(s) 119, which may be used by computer 101, may include computer executable instructions for invoking user functionality related to communication, such as e-mail, Short Message Service (SMS), and voice input and speech recognition applications. Application program(s) 119 (which may be alternatively referred to herein as “plugins,” “applications,” or “apps”) may include computer executable instructions for invoking user functionality related to performing various tasks. The various tasks may be related to interactive IVR hubs. It should be noted that, for the purposes of this application, IVR architecture and/or IVR hubs and/or IVR should be understood to refer to an intelligent front-end/back-end system that aids an agent and/or entity in responding to customer requests.

Computer 101 and/or terminals 141 and 151 may also be devices including various other components, such as a battery, speaker, and/or antennas (not shown).

Terminal 151 and/or terminal 111 may be portable devices such as a laptop, cell phone, Blackberry TM, tablet, smartphone, or any other suitable device for receiving, storing, transmitting and/or displaying relevant information. Terminals 151 and/or terminal 111 may be other devices. These devices may be identical to system 100 or different. The differences may be related to hardware components and/or software components.

Any information described above in connection with database 111, and any other suitable information, may be stored in memory 115. One or more of applications 119 may include one or more algorithms that may be used to implement features of the disclosure, and/or any other suitable tasks.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices. It should be noted that such modules may be considered, for the purposes of this application, as engines with respect to the performance of the particular tasks to which the modules are assigned.

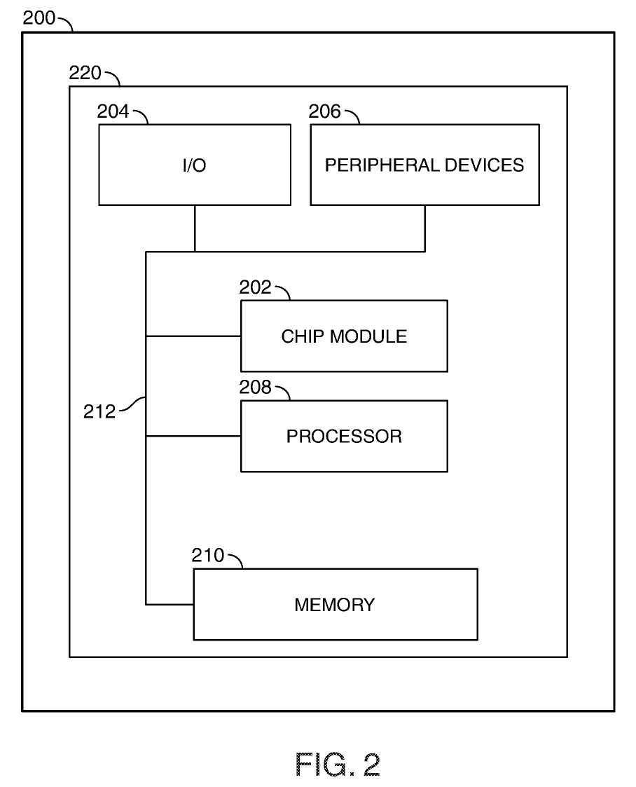

FIG. 2 shows illustrative apparatus 200 that may be configured in accordance with the principles of the disclosure. Apparatus 200 may be a computing machine. Apparatus 200 may include one or more features of the apparatus shown in FIG. 1. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions (which may be alternatively referred to herein as “computer instructions” or “computer code”), applications, signals, and/or any other suitable information or data structures.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

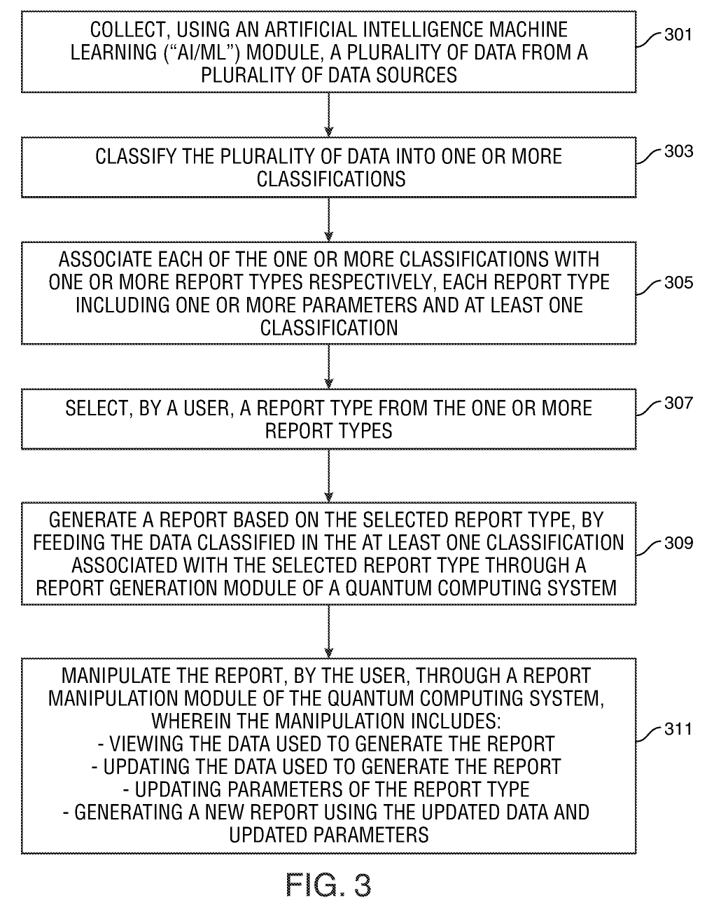

FIG. 3 shows an illustrative flow diagram in accordance with the principles of the disclosure. Step 301 shows the quantum computing system collecting, using an artificial intelligence machine learning (“AI/ML”) module, a plurality of data from a plurality of data sources. Step 303 shows the quantum computing system classifying the plurality of data into one or more classifications. Step 305 shows the quantum computing system associating each of the one or more classifications with one or more report types respectively, each report type including one or more parameters and at least one classification.

Step 307 shows the quantum computing system selecting, by a user, a report type from the one or more report types. Step 309 shows the quantum computing system generating a report based on the selected report type, by feeding the data classified in the at least one classification associated with the selected report type through a report generation module of a quantum computing system.

Step 311 shows the quantum computing system manipulating the report, by the user, through a report manipulation module of the quantum computing system. The manipulation may include viewing the data used to generate the report, updating the data used to generate the report, updating parameters of the report type and generating a new report using the updated data and updated parameters.

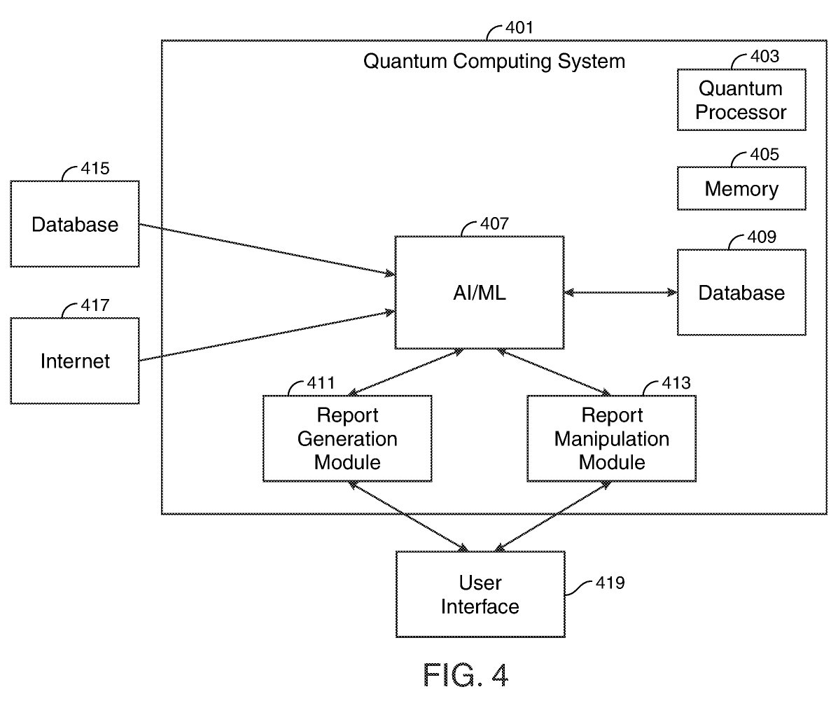

FIG. 4 shows another illustrative diagram in accordance with the principles of the disclosure. Quantum computing system 401 may include one or more quantum computers. Quantum computing system 401 may include quantum processor 403. Quantum computing system 401 may include memory 405. Quantum computing system 401 may include artificial intelligence machine learning (“AI/ML”) module 407. Quantum computing system 401 may include database 409. Quantum computing system 401 may include report generation module 411. Quantum computing system 401 may include report manipulation module 413.

AI/ML module 407 may communicate with database 409. AI/ML module 407 may communicate with report generation module 411. AI/ML module 407 may communicate with report manipulation module 413. AI/ML module 407 may receive data from database 415. AI/ML module 407 may receive data from internet 417.

Report generation module 411 may communicate with user interface 419. Report manipulation module 413 may communicate with user interface 419. Report generation module 411 may communicate with report manipulation module 413.

Thus, a data analysis to create real-time data generation is provided. Persons skilled in the art will appreciate that the present invention can be practiced by other than the described embodiments, which are presented for purposes of illustration rather than of limitation. The present invention is limited only by the claims that follow.

What is claimed is:

1. A method for dynamically modifying a report in real-time, the report being generated through the use of a quantum computing system, the method comprising:
collecting, using an artificial intelligence machine learning (“AI/ML”) module of the quantum computing system, a plurality of data from a plurality of data sources, the plurality of data sources including:
previously generated reports;
a centralized database; and
publicly accessible sources;
classifying the plurality of data into one or more classifications;
associating each of the one or more classifications with one or more report types respectively, each report type including one or more parameters and at least one classification;
selecting, by a user, a report type from the one or more report types;
generating the report based on the selected report type, by feeding the data classified in the at least one classification associated with the selected report type through a report generation module of the quantum computing system; and
manipulating the report, by the user, through a report manipulation module of the quantum computing system, wherein the manipulating includes:
viewing the data used to generate the report, on a user interface (“UI”);
updating the data used to generate the report by adding to, removing or editing portions of the data used to generate the report;
updating the parameters of the report type by adding to, removing or editing portions of the parameters; and
generating a new report using the updated data and updated parameters.

2. The method of claim 1 wherein:
the report manipulation module includes a generative AI engine;
the generative AI engine receives an input from the user;
the input is in natural language form;
the generative AI engine analyzes the input for a user intent; and
the generative AI engine performs the manipulating based upon the user intent.

3. The method of claim 1 wherein:
the AI/ML performs the collecting, the classifying and the associating dynamically;
the plurality of data sources provide data via multiple live data feeds; and
the AI/ML includes neutral data aggregators to manage the live data feeds.

4. The method of claim 3 further comprising:
creating, by the AI/ML before the classifying, datapoints upon collecting the data feed; and
storing the created datapoints in the centralized database.

5. The method of claim 4 wherein the quantum computing system verifies the data received from the publicly accessible sources.

6. The method of claim 1 wherein:
the classifying includes predicting, by a quantum predictor module, a use for new data; and
the predicting includes comparing the new data to the previously generated reports and the datapoints from the centralized database.

7. The method of claim 2. the report manipulation module shows the user the report on the UI and dynamically changes, in real-time, the report to the new report based on the manipulating.

8. The method of claim 7 wherein the UI includes a field for the input on a same screen as the report.

9. A system for dynamically modifying a report in real-time, the report being generated through the use of a quantum computing system, the system comprising:
a processor;
a memory; and
a non-transitory computer readable medium storing instructions that when executed by the processor:
collect, using an artificial intelligence machine learning (“AI/ML”) module of the quantum computing system, a plurality of data from a plurality of data sources, the plurality of data sources including:
previously generated reports;
a centralized database; and
publicly accessible sources;
classify the plurality of data into one or more classifications;
associate each of the one or more classifications with one or more report types respectively, each report type including one or more parameters and at least one classification;
select, by a user, a report type from the one or more report types;
generate the report based on the selected report type, by feeding the data classified in the at least one classification associated with the selected report type through a report generation module of the quantum computing system; and
manipulate the report, by the user, through a report manipulation module of the quantum computing system, wherein the manipulation includes:
viewing the data used to generate the report on a user interface (UI”);
updating the data used to generate the report by adding to, removing or editing portions of the data used to generate the report;
updating the parameters of the report type by adding to, removing or editing portions of the parameters; and
generating a new report using the updated data and updated parameters.

10. The system of claim 9 wherein:
the report manipulation module includes a generative AI engine;
the generative AI engine receives an input from the user;
the input is in natural language form;
the generative AI engine analyzes the input for a user intent; and
the generative AI engine performs the manipulation based upon the user intent.

11. The system of claim 9 wherein:
the AI/ML executes the collecting, the classifying and the associating dynamically;
the plurality of data sources provide data via multiple live data feeds; and
the AI/ML includes neutral data aggregators to manage the live data feeds.

12. The system of claim 11 wherein the instructions that when executed by the processor further comprise:
creating, by the AI/ML before the classifying, datapoints upon collecting the data feed; and
storing the created datapoints in the centralized database.

13. The system of claim 12 wherein the quantum computing system verifies the data received from the publicly accessible sources.

14. The system of claim 9 wherein:
the classifying includes predicting, by a quantum predictor module, a use for new data; and
the predicting includes comparing the new data to the previously generated reports and the datapoints from the centralized database.

15. The system of claim 10. the report manipulation module shows the user the report on a user interface (“UI”) and dynamically changes, in real-time, the report to the new report based on the manipulating.

16. The system of claim 15 wherein the UI includes a field for the input on a same screen as the report.

17. A method for dynamically modifying a report in real-time, the report being generated through the use of a quantum computing system, the method comprising:
collecting, using an artificial intelligence machine learning (“AI/ML”) module of the quantum computing system, a plurality of data from a plurality of data sources, the plurality of data sources including:
previously generated reports;
a centralized database; and
publicly accessible sources;
creating, by the AI/ML, respective datapoints from the collected plurality of data;
classifying the datapoints into one or more classifications;
storing the created datapoints in the centralized database;
associating each of the one or more classifications with one or more report types respectively, each report type including one or more parameters and at least one classification;
selecting, by a user, a report type from the one or more report types;
generating the report based on the selected report type, by feeding the data classified in the at least one classification associated with the selected report type through a report generation module of the quantum computing system; and
manipulating the report, by the user, through a report manipulation module of the quantum computing system, wherein the manipulating includes:
viewing the data used to generate the report, on a user interface (“UI”);
updating the data used to generate the report by adding to, removing or editing portions of the data used to generate the report;
updating the parameters of the report type by adding to, removing or editing portions of the parameters; and
generating a new report using the updated data and updated parameters.

18. The method of claim 17 wherein:
the report manipulation module includes a generative AI engine;
the generative AI engine receives an input from the user;
the input is in natural language form;
the generative AI engine analyzes the input for a user intent; and
the generative AI engine performs the manipulating based upon the user intent.

19. The method of claim 17 wherein:
the AI/ML performs the collecting, the classifying and the associating dynamically;
the plurality of data sources provide data via multiple live data feeds; and
the AI/ML includes neutral data aggregators to manage the live data feeds.

20. The method of claim 17 wherein:
the classifying includes predicting, by a quantum predictor module, a use for new data; and
the predicting includes comparing the new data to the previously generated reports and the datapoints from the centralized database.
